(19) United States
(12) Patent Application Publication
(10) Pub. No.: US 2015/0243244 A1
(43) Pub. Date: Aug. 27, 2015

(54) ACCESSORY HAVING A DISPLAY

(71) Applicant: Yoo Chol Ji, Seoul (KR)

(72) Inventor: Yoo Chol Ji, Seoul (KR)

(21) Appl. No.: 14/613,946

(22) Filed: Feb. 4, 2015

(30) Foreign Application Priority Data
Feb. 5, 2014 (KR) 10-2014-0013272

(51) Int. Cl. G09G 5/00; G09G 5/18; G06T 1/20

(52) U.S. Cl. CPC G09G 5/006; G06T 1/20; G09G 5/18

(57) ABSTRACT

This invention is related to an accessory or a set of accessories which is able to change design images. Further, this invention is related to an accessory which is able to change design images in synchronization with other accessory or device. An accessory according to this invention can show various design images, such that the accessory can selectively show a design image which are suitable for season, place, or clothes. And, by simple manipulation, user can easily set harmonized design images between accessories in hand.

### CROSS-REFERENCE TO RELATED APPLICATION

This application claims priority under 35 U.S.C. §119(a) of Patent Application No. 10-2014-0013272, filed on Feb. 5, 2014 in Korea, the entire content of which is incorporated herein by reference.

### TECHNICAL FIELD

This invention is about an accessory or a set of accessories which have a display on which design is changeable. And, this invention is also about an accessory which has a display on which design is changeable in harmonization with other accessory or other device. The type of accessory in this invention comprises anything which can be carried and give aesthetic effects outwardly, as well as general accessory such as necklace, ear-ring, and ring. A display of the accessory in this invention may be small-sized and has a characteristic of low power consumption.

### BACKGROUND

Accessory comprehensively means any item which can be carried on user's body or portably in order to give aesthetic effects outwardly. To the category of accessory, traditionally, ring, necklace and ring belong. Accessory can be made from various materials, metals like gold or silver, minerals like diamond or ruby, or natural material like pearl.

Traditional accessory generally is design with a single fixed shape, pattern or color. That is, a traditional accessory has only a fixed single design. Therefore, people purchase many accessories with various design, and choose to carry on accessory which matches with clothes or place to go. To such a reason, people who is sensitive to design has to pay quite money to buy many accessories. In case of purchasing a set of multiple accessories, people should spend more money than purchasing one accessory.

Recently, as high density display with slim thickness and low power consumption has been developed, it is attempted to overcome the limit of traditional accessory having a fixed single design.

### DISCLOSURE

### Technical Problem

An accessory or a set of accessories with variously changeable design, which does not make user easily feel bored with it and allows user to adjust its design to be suitable with user's clothes or place to go, is required. Further, in a set of accessories including at least two accessories, it is required that design change in one accessory can make design of the entire accessories change in a single concept or harmonization with each other.

### SUMMARY

As an embodiment of this present invention, an accessory comprises a display panel which is located in a side of the accessory and configured to show a design image; a memory which is located under the display panel, and stores a plurality of design images and information on an external device operating in synchronization therewith; a controller which reads and provides multiple design images for user's selection, changes a displayed design image with what user selected, and delivers an identifier of the selected design image toward a communication part, the communication part transmitting information on the identifier of the selected design image to other accessory which is registered in the memory; a battery which provides power to the display panel, the memory, the communication part and the controller; a housing which encloses the memory, the communication part and the controller together with the display panel; and a connector which is connected to the housing for carrying on by user.

And, as another embodiment of this present invention, a set of accessories comprises a first accessory, which includes a first display panel; a first memory which stores a plurality of design images and information on an external device operated in harmonization or synchronization with the first accessory; a first controller which reads a plurality of design images from the first memory, provides them to the first display panel for user's selection, and delivers an identifier of the selected image to a communication module; and, a first communication part which transmits the identifier of the selected image to an external device which is registered in the first memory, and a second accessory, which includes a second display panel; a second memory which stores a plurality of design images and information on an external device operated in harmonization or synchronization with the second accessory; a second communication part which receives design images from the first accessory; and a second controller which retrieves a design image stored in the second memory based on the image identifier delivered from the second communication part, and delivers it to the second display panel.

As another embodiment of this present invention, a set of portable electric devices comprises a first portable electric device and a second portable electric device.

The first portable electric device comprises a first display panel; a first memory which stores a plurality of design images and unique information on the second portable electric device for communicating it; a first controller which controls the first display panel to display a design image selected out of a plurality of design images; and a first communication part which transmits the selected design image to the second portable electric device, which has been already registered in the first memory, by control of the first controller.

And the second portable electric device comprises a second display panel; a second communication part which receives the selected design image from the first portable electric device; and a second controller which controls the second display panel to display a design image based on design image information received from the second communication part.

In embodiments of this present invention, a plurality of design images may be provided by accessory manufacturer, made by user himself or herself, or made by expert and then downloaded from a server. A plurality of design images may be provided in a plurality of categories of image concept or designer. For convenience of user when selecting design image, recommended design images depending on season or place may be provided.

In embodiments of a set of accessories, design change of accessories may be made in synchronization with each other by particular pre-setting, or may be made by time setting like alarm setting. And, basically, accessories in a set may be set to have a same design image at a preset time, to have different design images with each other at a preset time, or to show each different design image at a different time, depending on user's preference. Also, it may be set for a plurality of design images to show up periodically. In this case, one accessory has design images changed periodically, but to the contrary, the other accessory has a design image fixed.

A set of accessories in this present invention may be a plurality of accessories which are sold together in a set, or sold separately but connected as a set by user.

Meanwhile, an accessory in this present invention may be attachable directly on human body, or be carried by user while being positioned on user's clothes. And, an accessory in this present invention includes an accessory for indicating a group or organization which user belongs to, such as a badge, as well as an accessory for aesthetic purpose.

Further, this invention may be applied between personal portable communication devices which are designed similarly as accessory, or between an accessory and a personal portable communication device, such that design images between them can be synchronized or harmonized with each other.

Meanwhile, as another embodiment of this present invention, a method to change design images on accessories comprises registering an identifier of a second accessory, which operates in synchronization with a first accessory, into a first accessory memory; displaying a plurality of design images on a first accessory display panel and waiting for user's selection of a design image that user wants; changing design image on the first accessory display panel with the selected design image; transmitting a design image ID information on the selected design image to the second accessory; and displaying a design image, which is retrieved from a second accessory memory based on the design image ID information, on a second accessory display panel.

### Advantageous Effects

An accessory or a set of accessories in this present invention comprises at least an electrically-operated high-density display panel, such that the accessory or the set of accessories can show realistic various design images. And, through an accessory or a set of accessories this invention provides, since user can select design images suitable for place or clothes in where user is, thus, user can get economical benefits just as purchasing several accessories or sets of accessories. And, in case of a set of accessories in this present invention, by changing a design image of one single accessory, it is possible to automatically and easily change design images of all other accessories which is operated in harmonization or synchronization with that single accessory.

### DESCRIPTION OF DRAWINGS

FIG. 1 shows a necklace as an embodiment of the invention.

FIG. 2 shows a function diagram of the necklace in the FIG. 1.

FIG. 3 shows an ear ring, which forms a set of accessories with the necklace in the FIG. 1, as an embodiment of the invention.

FIG. 4 shows a display in a design image setting mode as an embodiment of the invention.

FIG. 5 shows a display in an accessory adding mode as an embodiment of the invention.

FIG. 6 shows a display in a reservation setting mode as an embodiment of the invention.

FIG. 7 shows a display in a repetition setting mode as an embodiment of the invention.

### DETAILED DESCRIPTION

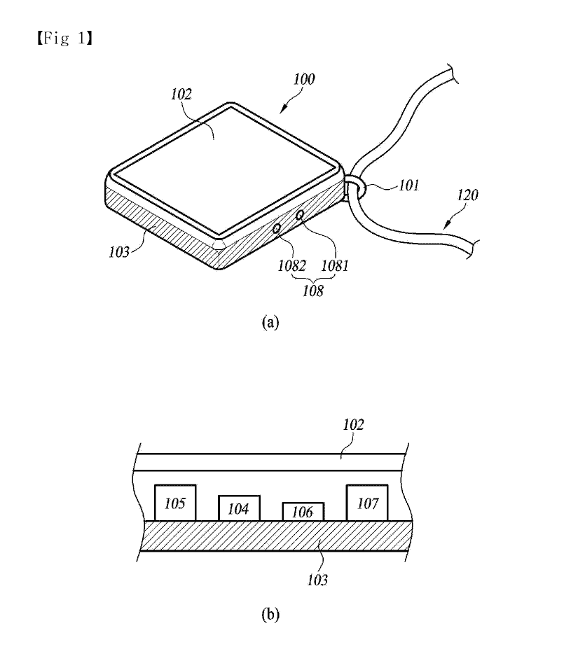

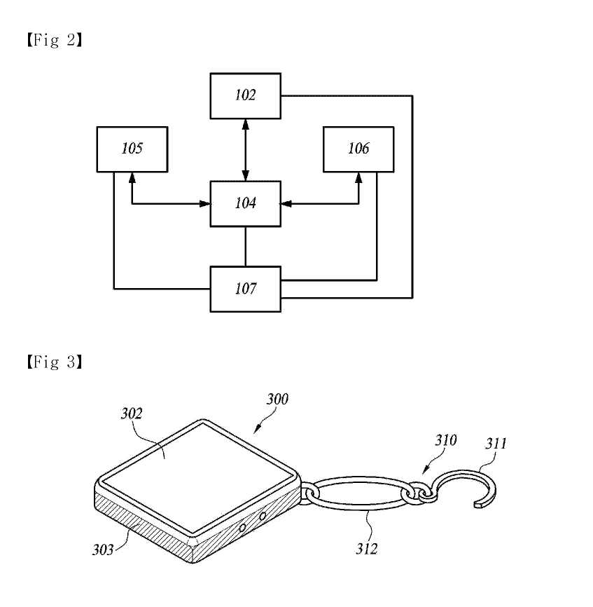

With the FIG. 1 to FIG. 7, an accessory or a set of accessories of this invention, and operation and setting mode thereof are explained in detail.

The FIG. 1 shows a necklace to which an embodiment of this invention is applied. The necklace comprises a display part (100) and a connecting part (120) which is connected to the display part and disposed around the neck of a user on use. The display part can be fixedly connected with the connecting part, or can relatively move to the display part a ring disposed between them.

The display part comprises a display panel (102) seen from the outside, a controller (104) which is located under the display panel and supplies electrical signals to the display panel, a communication part (105) which wirelessly sends or receives information with the outside, a memory (106) storing information on design images which has been already received or is received from the communication part, a compact battery (107) which supplies electricity to the controller, the communication part, and the memory, and a housing (103) which is located under the display part and encloses the controller and the communication part with the display panel.

The display panel may have various structures depending on kinds of display technology. The display panel in this invention may be OLED (Organic Light-Emitting Diode) display, which has merits of thin thickness, low power loss, and high brightness over other display device.

In case that OLED display is applied, the display panel may comprise a light generating part, a cover part which covers the light generating part, and a circuit board which the light generating part is mounted on. Because the housing encloses the communication part, it may be made of non-metal material to minimize effects on wireless signals.

And, the communication part may comprise a near field communication module which can communicate with other accessories in a near distance, and WLAN or Bluetooth module for communication with a PC/Tablet.

The connecting part may be made of metal material resistant to deformation, or alternatively, of easily deformable material for flexibility in use. As another embodiment, a necklace may comprise several or a few small displays which are connected with each other in a determined pattern. In this embodiment, display area seen from the outside is large, such that the necklace gives more visual effects to the outside.

The housing (103) in the display part (100) may comprises a plurality of buttons, which are connected to the controller. Using the buttons, a user can select one of design images which have been already stored in the memory, or are remotely received from the outside, and make the selected design image to be shown on the display part.

Buttons can be seen from the outside or interfere with human body. Due to such demerits, by touching soft keys in the display panel instead of buttons, similar functions can be realized. That is, if a user would want to change design image in his accessory, after switching to a design setting mode by the soft keys on the display panel, he can change it by again touching what he want on the display panel.

FIG. 3 shows an ear ring, which forms a set of accessories with the necklace in the FIG. 1. The ear ring comprises a display part (300) and a connecting part (310). The display part (300) represents characteristic of ear ring design, and can show various colors or patterns. The connecting part (310) may comprise a fixing hook (311) and a ring (312) which connects the display part and the fixing hook.

The display part (300), substantially similar as the necklace in the FIG. 1, comprises a display panel (302) seen from the outside, a controller which is located under the display panel and supplies electrical signals to the display panel, a communication part which receives or sends information, a memory which stores design information provided by the manufacturer or transferred from the communication part, a compact battery which supplies power to the controller, the communication part, and the memory, and a housing which is located under the display panel and encloses the controller and the communication part with the display panel.

The display panel of the ear ring may have various structures depending on type of display panel. Like as the necklace, the display panel may have slim thickness and also may have an OLED display panel which has advantages in term of low power consumption, high brightness and high resolution.

Meanwhile, the communication part may have a near field communication module which enables to communicate with other devices, a Bluetooth module and a wireless LAN module.

The display parts of the necklace in the FIG. 1 and the ear ring in the FIG. 3 are operated in synchronization or harmonization with each other, such that two display parts may be controlled to show design images having same aesthetic sense. At first, in order to make two accessories coupled with each other, it is necessary to register the necklace into the ear ring. This stage is described in detail in ‘an accessory adding mode’ later.

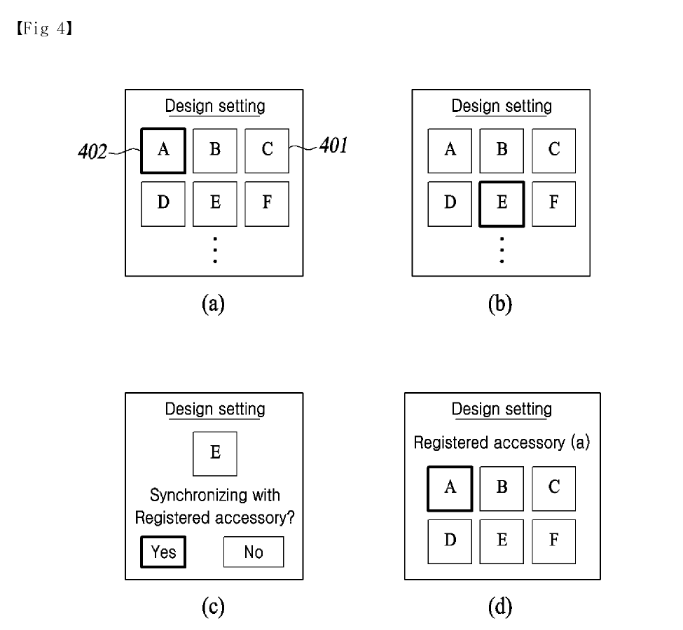

The FIG. 4 shows a display in the display part of the necklace, for setting the necklace and the ear ring show same images. That is, if user pushes a setting button (1081) one time, operating mode is changed as a design setting mode, while showing multiple design images (401) selectable by user. (FIG. 4a)

In order for user to select a design image suitable for current clothes or place, user may move a selection cursor (402) on a particular design image by pushing a moving button (1082). (FIG. 4b)

For selecting the particular design image finally, user may need to push the setting button (1081) again. If the particular design image is selected finally, a display may show, which asks whether to change design images of the necklace and the ear ring with the same design image or not. (FIG. 4c)

If user wants to change them as same, user may select ‘yes’ by pushing the setting button (1081) again. Then, the display parts of the necklace and the ear ring are changed to show a same design image.

To the contrary, if user wants to change them differently with each other, user may move the selection cursor on ‘no’, and finally select ‘no’ by pushing the setting button (1081) again. Then, in the next display, a plurality of design images are shown for selecting a design image for the ear ring (′registered accessory (a)′ at FIG. 4d), and in a similar way as explained above, user can select a design image for the ear ring.

A control flow of design change process is like the following. If user pushes a setting button (1081) of the necklace at FIG. 1, a controller (104) reads multiple design information from a memory (106) and shows it on a display panel (102).

Each design image has an own unique ID number. In accordance with a display order of multiple design images in the display panel, ID numbers of design images are listed orderly in the memory. If user moves a selection cursor on a design image he wants, by pushing a moving button (1082), the controller counts times of pushing the moving button.

Then, if user pushes the setting button (1081), according to the times of pushing the moving button, the controller retrieves a corresponding design image ID number out of design image ID number list in the memory, and recognizes the design image user selected finally.

In case that user wants to set a design image of the ear ring as same as that of the necklace, the design image ID number selected in the former step is transmitted to the ear ring via the communication part (105) of the necklace. The communication part (105) of the ear ring delivers the received design image ID number to the controller of the ear ring. And, then, the controller retrieves a design image stored in the memory by utilizing the received design image ID number, and displays it on the display panel (302) of the ear ring.

As one embodiment, changing a design image of the ear ring by manipulating buttons disposed in the necklace is described in the above. However, it is also possible to change a design image of the necklace by manipulating buttons disposed in the ear ring. For both the necklace and the ear ring to operate in couple (synchronization or harmonization) with each other, each of the necklace and the ear ring need to have an own unique device ID, and each of them may need to be set to communicate only with a particular device.

Additionally, in case that a finger ring is available by user, the finger ring also can be set to operate in couple (synchronization or harmonization) with other accessories. The necklace may be set to communicate only with the ear ring or the finger ring.

The number of accessories which can communicate with the necklace has no limitation. Thus, that number can be increased depending on user's choice or a criterion that manufacture preset. As the number of devices which can operate in couple with the necklace increases, in a design change mode, the number of times to ask whether an accessory have a same design image as that of the necklace will increase.

In this invention, it is possible to add an accessory which would operate in couple with the necklace. The FIG. 5 shows a display for setting an additional accessory.

Firstly, by pushing the setting button (1081) twice, user may proceed to ‘accessory adding mode’. Then, on the display panel of the necklace, a plurality of identifiers for accessories which can be registered into the necklace may be shown. (FIG. 5a) After moving the cursor button (502) by pushing the moving button (1082), use can select an accessory which is required to operate in couple (harmonization or synchronization) with the necklace. (FIG. 5b) For convenience in the former step, it is possible for user to select one accessory or a plurality of accessories at one selection.

In case of setting by touching the display panel instead of buttons, by touching the display panel (102) consecutively twice, a display for setting may be seen. That is, if user touches the display panel consecutively twice, options of ‘design setting’ and ‘accessory adding’ may be seen. For the first, if a corresponding area of ‘design setting’ on the display panel is touched, a plurality of design images may be shown. Then, user can select a design image he wants, by touching a corresponding area of the design image wanted.

In case that other device which operates in couple has been registered, user can determine whether the other device should show the same design image or not. If no, a display for selecting a design image for the other device is shown additionally.

On the other hand, if a corresponding area of ‘accessory adding’ on the display panel is touched, a plurality of accessory identifiers which are able to be added are shown. If user wants to add a particular accessory, user may touch a corresponding area of a particular accessory identifier on the display panel, and need to input a password which is required by that particular accessory.

This invention can be utilized by a pair of lovers, who want to have same accessories with each other. In case that each of a pair of lovers has an accessory in this present invention, after one person registers the other person's accessory into one's own accessory, two accessories may be set to show a same design image. To show a design image unique to a pair of lovers, they may be able to make own unique design images by using an application program provided by the manufacturer, and to download those design images to one of accessories. Then, following the forementioned steps, they can change design images of both accessories.

In case that a pair of lovers wants to change design images of finger rings, which the present invention applied to, same as each other, they move their finger rings in a near distance. Then, by touching the display panel in a finger ring, a display for setting can be seen on the display panel.

At the display for setting, the option of ‘accessory adding’ is shown. If this option is selected, in the next display, multiple identifiers of accessories which can communicate with the finger ring are shown. At this step, they can select a finger ring identifier of the partner. In case that a password in the partner's finger ring has been preset, they have to input the exact password in order to finally add the partner's finger ring.

After adding the partner's finger ring, user can come back to the setting display, and select the option of ‘design change’. Then, on the display panel, all design images selectable are shown in the display panel. If a design image wanted is selected, whether to change other accessory with the selected design image as well is asked. If ‘yes’ is selected, the already-added partner's finger ring also show the same image as the selected. If the pair of lovers has necklaces, after those necklaces are registered additionally, those necklaces also can show the same design image.

Design images in the present invention may be design images that manufacturer provides, and thus user has downloaded from the website of the manufacturer. Design images may be provided in each category, for user to select more easily what he/she wants out of many design images, such as classic, modern, oriental and etc. Also, categories may be each name of designers.

An accessory or a set of accessories in the present invention may have a function of setting a schedule. User can set a schedule to automatically change design images depending on the time. For example, user can make design image change suitably for circumstances and feeling at the time of a day, such as, design image ‘A’ from 6 AM to 12 AM, design image ‘B’ from 12 AM to 6 PM, and design image ‘C’ from 6 PM to AM 6 of the next day.

Further, notice function also may be added. User can set a notice, which is to automatically show a particular design image on a particular date. For example, user can set an accessory to show a design image symbolizing a party on the user's birthday, letting user not forget the meaningful date.

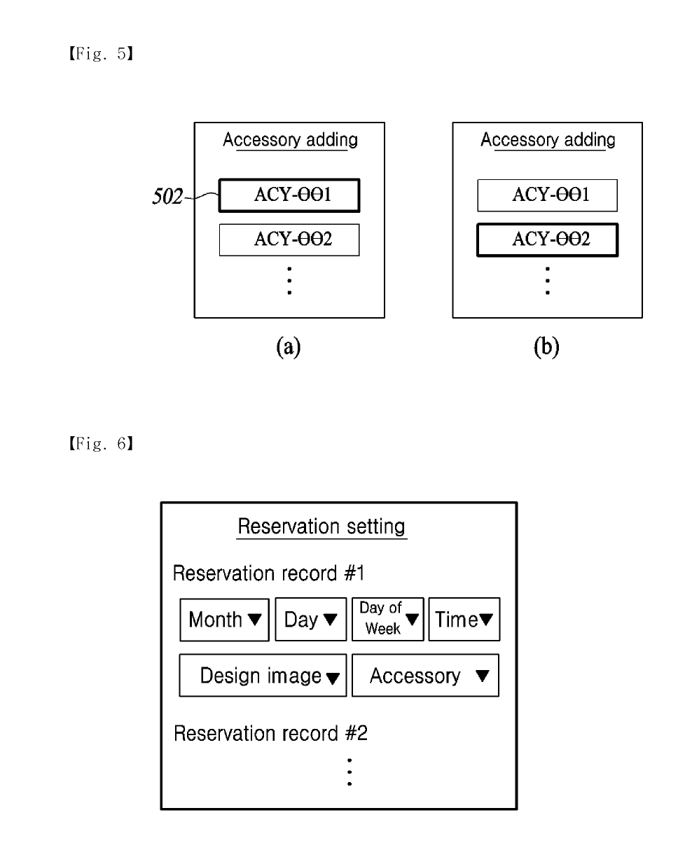

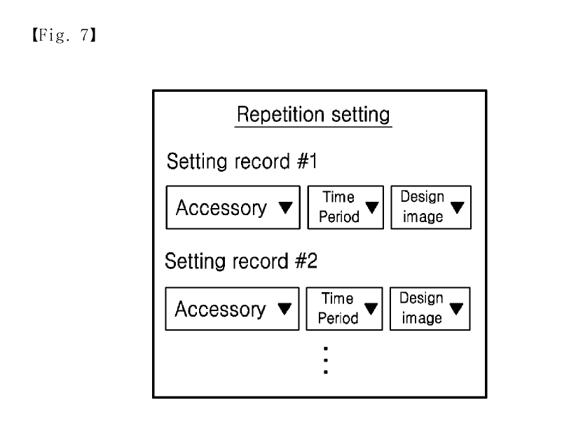

The steps for setting design images to change according to the time are described more in detail in the FIG. 6. User can proceed to a setting display by touching the display panel (102) consecutively twice. On the setting display, an option of ‘reservation setting’ may be shown.

In case of using a button to change modes, use may proceed to a setting display by pushing the button consecutively three times. On the display, there are a plurality of records for making a plurality of reservations. Each record has option boxes to input month, day, day of week, time, design image, and target accessory. (FIG. 6)

If user wants to make a reservation on a particular date, use can input a month and day via corresponding selection boxes thereof, as he/she wants. If user wants to make a reservation on a particular day of the week, use can select a day of the week likewise via corresponding selection box, and even select ‘everyday’. In the design image selection box, use can select a representing name of a design image out of list names, or see and select a partial feature of a design image out of listed partial features.

And, the option of ‘reservation setting’ can be applied only to a particular accessory, or applied to all accessories registered to operate in synchronization.

In addition to the ‘reservation setting’ which enables design images to change at a designated time, an option of ‘repetition setting’ can be additionally configured. At the ‘repetition setting’ option, it can be set for design images to change periodically. This function enables design images to change automatically and periodically in an accessory, such that other people can easily notice the accessory.

By touching the display panel consecutively twice, user can proceed to a setting display. At the setting display, an option of ‘repetition setting’ may be shown.

In case of using a button on an accessory, by pushing a button four times consecutively, user can directly proceed to the option of ‘repetition setting’. On the display of ‘repetition setting’, user can set different repetition settings between different accessories. For the setting, there are a plurality of setting records, and each record has selection boxes for selecting a target accessory, repetition period, and a design image. (FIG. 7)

In case that all registered accessories are intended to perform repetition action with same design image and in same period, user can simply check ‘all’ in an accessory selection box.

Repetition period means a waiting time until a new design image replaces a previous design image. And it may be in the range of from 1 minute and 10 minutes. Design images to be repeated may be all of the design images stored in a memory, or may be particular some of design images.

In this description, as examples of accessory, accessories which are used generally with being attached on human body (such as, necklace, ear ring, and finger ring) are cited. However, this invention may be applied to accessories which are used generally with being attached on clothes. (such as, brooch, cuffs, hairpin, badge, and button)

Meanwhile, a design image newly shown on one accessory may not be exactly the same as a design image newly shown on the other accessory which operates in synchronization with the one accessory. Design images on both accessories in synchronization with each other may have similar colors or patterns. For example, design images may have a same or similar color but a different pattern, or have a same or similar pattern but a different color. Further, depending on which design images on both synchronized accessories are linked with each other, design images on both synchronized accessories may be same, similar, or different in some cases.

1. An accessory comprising:
a display panel which is located in a side of the accessory and configured to show a design image;
a memory which is located under the display panel, and stores a plurality of design images and information on an external device operating in synchronization therewith;
a controller which reads and provides multiple design images for user's selection, changes a displayed design image with what user selected, and delivers an identifier of the selected design image toward a communication part, the communication part transmitting information on the identifier of the selected design image to other accessory which is registered in the memory,
a battery which provides power to the display panel, the memory, the communication part and the controller;
a housing which encloses the memory, the communication part and the controller together with the display panel; and
a connector which is connected to the housing for carrying on by user.

2. The accessory according to claim 1, wherein the design images are made in other device by using an application program that an accessory manufacturer supplies, and then downloaded to the memory.

3. The accessory according to claim 1, wherein a plurality of design images are provided in a plurality of categories.

4. The accessory according to claim 1, wherein the controller provides a setting display for setting a time when the selected design image is shown on the display panel.

5. The accessory according to claim 1, wherein the controller provides a setting display for setting a time period when the selected design images are shown alternatively on the display panel

6. The accessory according to claim 1, wherein the external device operating in synchronization with the accessory is another kind of accessory which an accessory manufacturer sells in a set.

7. A set of accessories comprising:
a first accessory, which includes a first display panel; a first memory which stores a plurality of design images and information on an external device operated in harmonization or synchronization with the first accessory; a first controller which reads a plurality of design images from the first memory, provides them to the first display panel for user's selection, and delivers an identifier of the selected image to a communication module; and, a first communication part which transmits the identifier of the selected image to an external device which is registered in the first memory, and
a second accessory, which includes a second display panel; a second memory which stores a plurality of design images and information on an external device operated in harmonization or synchronization with the second accessory; a second communication part which receives design images from the first accessory; and a second controller which retrieves a design image stored in the second memory based on the image identifier delivered from the second communication part, and delivers it to the second display panel.

8. The set of accessories according to claim 7, wherein the design images are made in other device by using an application program that an accessory manufacturer supplies, and then downloaded to the first memory.

9. The set of accessories according to claim 7, wherein a plurality of design images are provided in a plurality of categories.

10. The set of accessories according to claim 7, wherein the first controller provides a setting display for setting a time when the selected design image is shown on the first and second display panel.

11. The set of accessories according to claim 7, wherein the first controller provides a setting display for setting a time period when the selected design images are shown alternatively on the first and second display panel.

12. The set of accessories according to claim 7, wherein the second accessory operating in synchronization with the first accessory is another kind of accessory which an accessory manufacturer sells in a set.

13. A set of portable electric devices comprising:
a first portable electric device comprises a first display panel; a first memory which stores a plurality of design images and unique information on the second portable electric device for communicating it; a first controller which controls the first display panel to display a design image selected out of a plurality of design images; and a first communication part which transmits the selected design image to the second portable electric device, which has been already registered in the first memory, by control of the first controller, and
a second portable electric device comprises a second display panel; a second communication part which receives the selected design image from the first portable electric device; and a second controller which controls the second display panel to display a design image based on design image information received from the second communication part.

14. The set of portable electric devices according to claim 13, wherein the design images are made in other device by using an application program that an accessory manufacturer supplies, and then downloaded to the first memory.

15. The set of portable electric devices according to claim 13, wherein a plurality of design images are provided in a plurality of categories.

16. The set of portable electric devices according to claim 13, wherein the first controller provides a setting display for setting a time when the selected design image is shown on the first and second display panel.

17. The set of portable electric devices according to claim 13, wherein the first controller provides a setting display for setting a time period when the selected design images are shown alternatively on the first and second display panel.

18. The set of portable electric devices according to claim 13, wherein the second portable electric device operating in synchronization with the first portable electric device is another kind of portable electric device which an manufacturer sells in a set
